(19) United States
(12) Patent Application Publication
(10) Pub. No.: US 2013/0149089 A1
(43) Pub. Date: Jun. 13, 2013

(54) SYSTEMS AND DEVICES FOR REMOVING MATERIALS FROM VACUUM TRUCK TANKS

(71) Applicants: Gary W. Harms, JR., Fort Morgan, CO (US); William David Rollins, Calgary (CA); Jennifer Orom, Bashaw (CA)

(72) Inventors: Gary W. Harms, JR., Fort Morgan, CO (US); William David Rollins, Calgary (CA); Jennifer Orom, Bashaw (CA)

(73) Assignee: PRO-TECH ENTERPRISES, LLC, Fort Morgan, CO (US)

(21) Appl. No.: 13/323,580

(22) Filed: Dec. 12, 2011

(51) Int. Cl. B60P 3/16

(52) U.S. Cl. 414/513

(57) ABSTRACT

Systems and devices for removing materials from vacuum truck tanks are disclosed herein. An exemplary system for removing materials from a vacuum truck may include a tank having one or more walls enclosing the tank and an opening in the one or more walls to facilitate removal of materials from the tank; a blade positioned within the tank and configured to push materials towards the opening to remove or discharge collected materials from the tank; and a drive mechanism configured to selectively move the blade towards the opening in the tank. Additional systems and devices for removing materials from vacuum truck tanks are also disclosed herein.

### BACKGROUND OF THE INVENTION

Vacuum trucks are truck-mounted heavy duty industrial vacuum loaders designed to pneumatically convey solids, liquids, sludge, slurry, or other materials through suction hoses into a collection tank. Vacuum trucks are utilized in a variety of industries (e.g., drilling, exploration, excavation, sewage collection, hazardous waste collection, refuse collection, etc.) for collecting a variety of materials. In addition to being useful in the collection of materials, vacuum trucks can also be used to transport the collected materials to another site for processing or disposal.

As a specific example, in drilling operations, a fluid commonly referred to as “mud” is circulated from the surface, downward through a drill pipe and out openings in the drill bit at the bottom of a borehole. After exiting the drill bit at the bottom of the borehole, the mud along with other material from the borehole (often referred to collectively as “cuttings”), are pushed back upward through the borehole to the surface. Once at the surface, the cuttings that are extracted from the borehole may be processed in order to separate the mud from the other material. The mud may then be recycled and sent back down the drill pipe, and the material that is separated from the mud may be collected into a separate area or container. The material that is separated from the mud, which is commonly referred to as “sludge,” may include a mixture of different solids, such as stone, dirt, clay, and salt. It is also common for sludge to include nonsolid components, such as water, oil, mud, and other fluids. Vacuum trucks can be very useful to collect, process, and/or transport the drilling mud and sludge. In particular, an operator can utilize the vacuum truck to suction the materials into a collection tank (often referred to as a “mud tank”), after which the vacuum truck can transport the collected materials to a different location for disposal or processing.

However, there are a number of disadvantages associated with conventional vacuum trucks and systems. As evident from the process above, the tank of the vacuum truck must be periodically emptied. According to conventional systems, removal of the materials from the tank is done by using hoists or other mechanisms to lift or tip the tank and dump the collected materials out of the tank. These systems result in an inefficient use of energy and time. In particular, the additional power and time needed to lift the entire tank to remove the collected materials results in additional expenses in the form of fuel and man-hours. Furthermore, the mechanisms necessary to lift the tank are complex and result in an increased manufacturing, purchase, and maintenance costs.

In addition, these conventional systems are often ineffective. For example, the vibrations of the vacuum trucks during travel or operation may compact collected materials within the tank, thereby causing the materials to adhere together and to the inner surfaces of the tank. As a result, merely lifting or tipping the tank may be insufficient to remove the materials from the tank. To remedy this, operators of the vacuum trucks may be forced to physically enter the tanks to manually remove or assist in removing the materials. This is an ineffective, inefficient, and unsafe system and method of removing materials from a vacuum tank. Forcing the operators to enter the tanks and manually remove the materials puts the operators in a dangerous situation that could result in injury from accident or overexertion. In addition, the moving parts necessary to lift or tip the tank create additional pinch points, not to mention instability, that can cause injury to those working on or nearby the vacuum truck.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates a perspective view of an exemplary system for removing materials from vacuum truck tanks, according to the principles described herein.

FIG. 2 illustrates a perspective view of various internal components of the exemplary system of FIG. 1, according to principles described herein.

FIG. 3 illustrates a side, partial cut away view of the exemplary system of FIG. 1, according to principles described herein.

FIG. 4 illustrates an end view of the exemplary system of FIG. 1, according to principles described herein.

FIG. 5 illustrates an end view of various internal components of the exemplary system of FIG. 1, according to principles described herein.

FIG. 6 illustrates a top view of various internal components of the exemplary system of FIG. 1, according to principles described herein.

FIG. 7 illustrates a spray bar of the exemplary system of FIG. 1, according to principles described herein.

FIG. 8 illustrates an exemplary vacuum truck, according to principles described herein.

FIG. 9 illustrates a perspective view of various internal components of another exemplary system for removing materials from vacuum truck tanks, according to the principles described herein.

### DETAILED DESCRIPTION

Exemplary systems and devices for removing materials from vacuum truck tanks are disclosed herein. As will be described in more detail below, in certain implementations, the systems and devices disclosed herein may be configured to allow a vacuum truck operator to efficiently, effectively, and safely remove collected materials from a tank of a vacuum truck. For example, the systems and devices disclosed herein may be configured to allow a vacuum truck operator to effectively remove collected materials from a vacuum truck's tank without the need for a mechanism to lift or tip the tank. In addition, the systems and devices disclosed herein may be configured to reduce or remove the need for manual intervention and physical labor to remove the materials from the vacuum truck's tank. Additional benefits and/or advantages will be apparent from the details disclosed herein.

As used herein, the term “vacuum truck” may be used to refer to any mobilized industrial vacuum loader including, but not limited to, wet and dry vacuum trucks, liquid-only vacuum trucks, hydro-excavation vacuum trucks (“hydrovac trucks”), sewage vacuum trucks, industrial air mover trucks, vacuum trailers, street cleaners, or any other suitable vacuum truck. Vacuum trucks may have varying sizes, capacities, and functions. Vacuum trucks may include structures and mechanisms to facilitate the process of pneumatically loading materials into the vacuum trucks. For example, vacuum trucks may include blowers, pumps, tanks, separators, filters, traps, silencers, boom lines, pipes, hoses, and/or any other suitable features configured to allow the vacuum truck to pneumatically collect waste materials. In some examples, one or more mechanisms (e.g., blowers or pumps) may be powered by one or more power take offs operably connected to a vacuum truck's engine.

Vacuum trucks may be used to collect a variety of waste materials in various forms. Waste materials may include wet materials, dry materials, liquids, solids, any other suitable materials, or combinations thereof. By way of example and not limitation, waste materials may include stone, dirt, debris, clay, salt, water, oil, dust, mud, sludge, slurry, hazardous waste, chemicals, sewage, etc.

Various principles disclosed herein are provided with relation to and within the context of a hydrovac truck. However, one will appreciate that the principles disclosed herein can be applied to any other suitable vacuum truck.

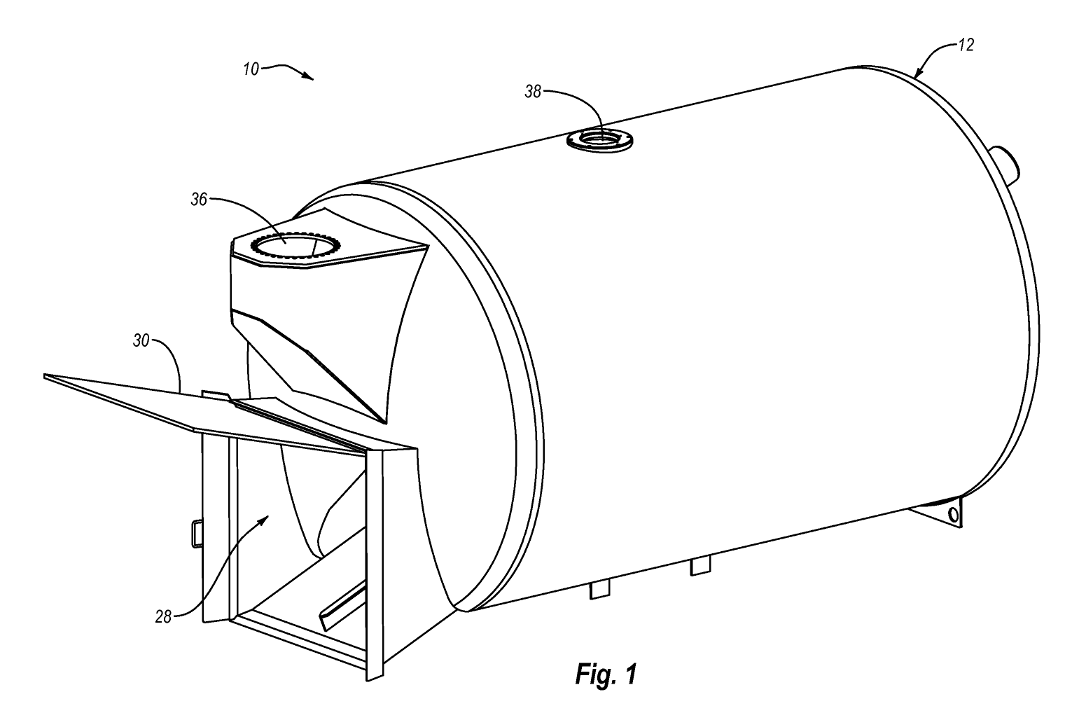

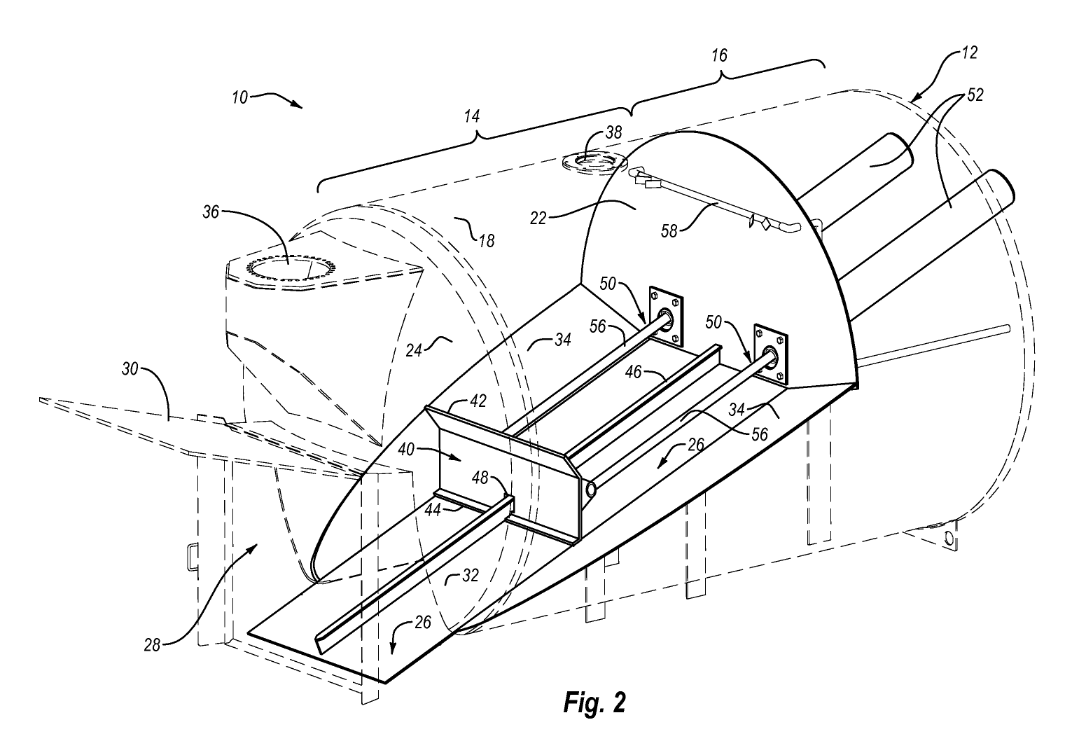

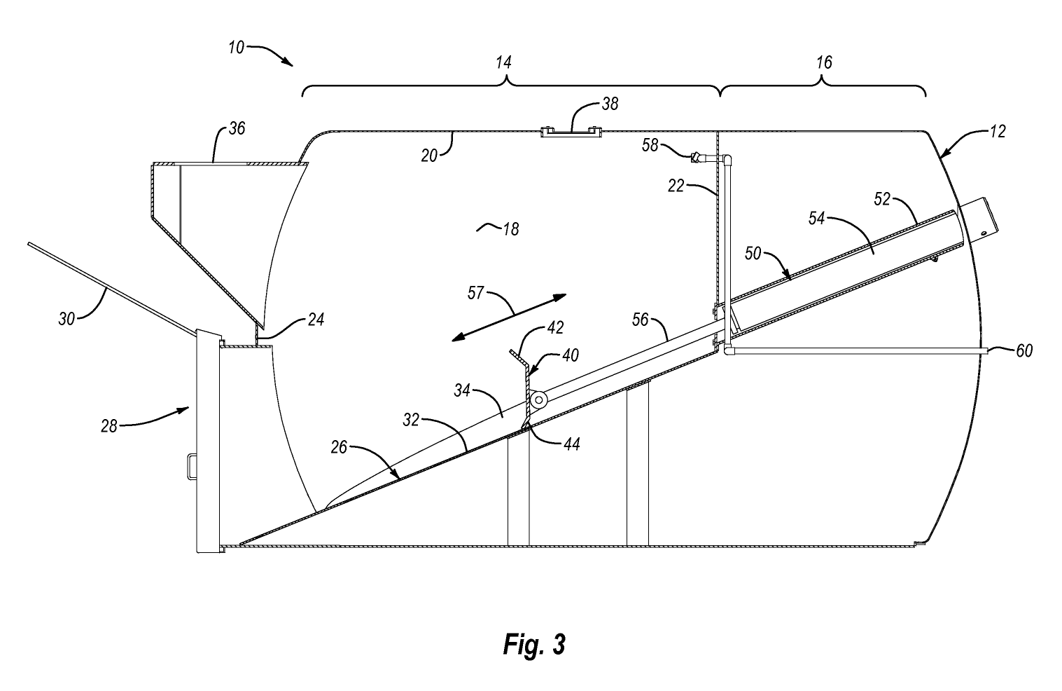

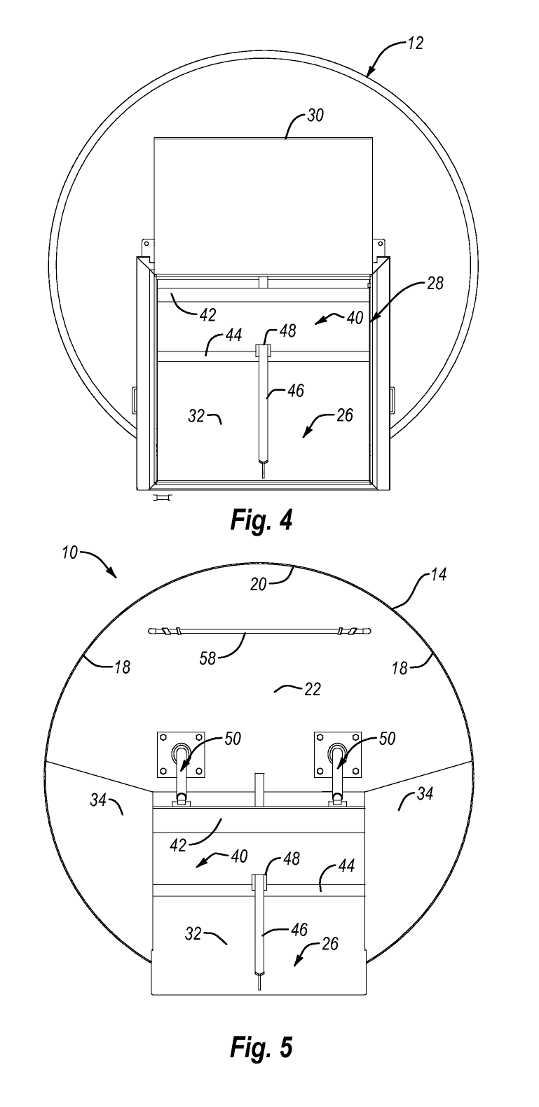

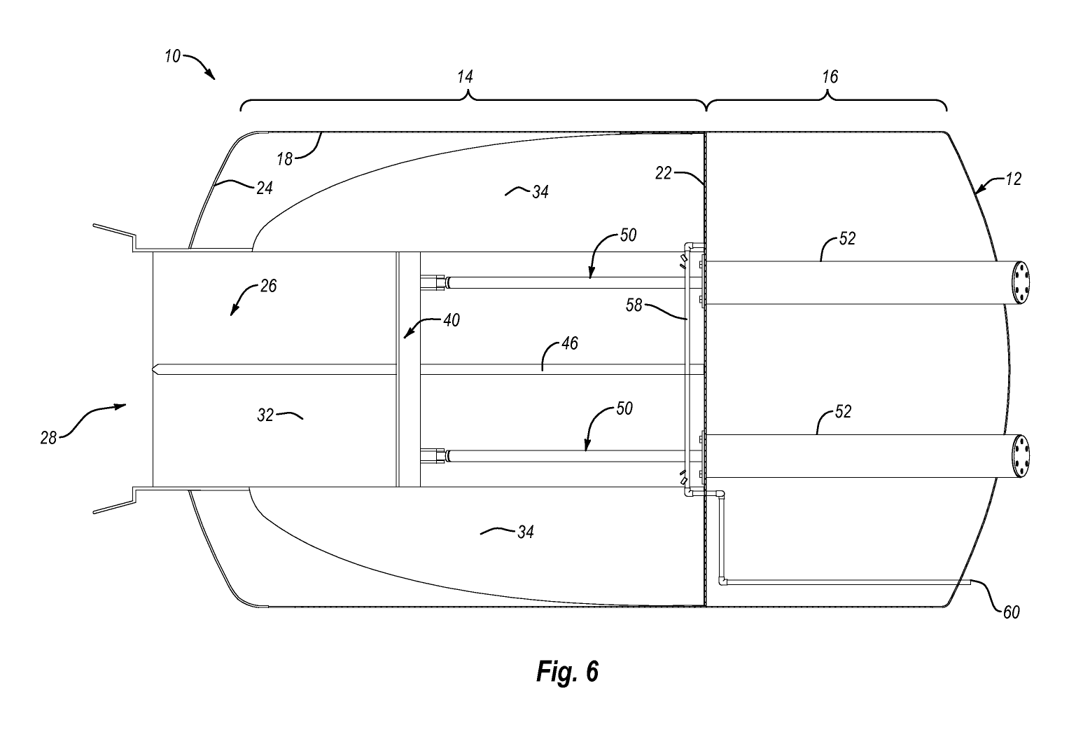

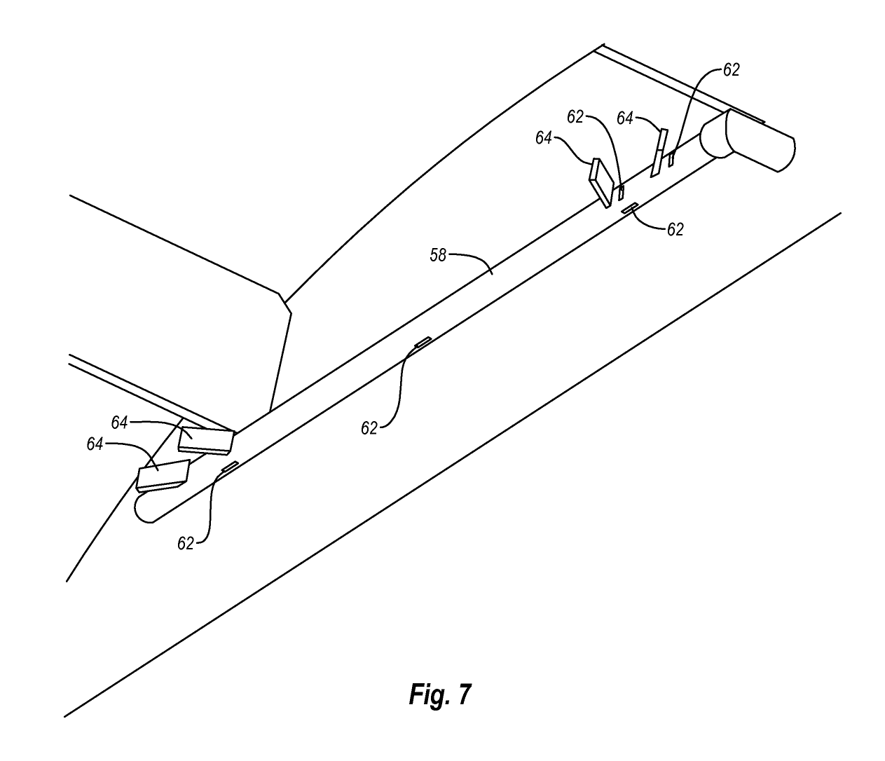

FIGS. 1 through 7 illustrate an exemplary system 10 for removing materials from a vacuum truck tank. In particular, FIG. 1 illustrates a perspective view of the exterior of system 10; FIG. 2 illustrates a perspective view of the interior of system 10 with the exterior represented by dashed lines; FIG. 3 illustrates a side cut-away view of system 10; FIG. 4 illustrates an end view of the exterior of system 10; FIG. 5 illustrates an end view of the interior of system 10; FIG. 6 illustrates a top view of the interior of system 10; and FIG. 7 illustrates a close-up view of a spray bar of system 10.

As shown in FIG. 1, system 10 may include a generally cylindrical tank system 12 (or simply “tank 12”) that may be mounted to the frame of a vacuum truck. Tank 12 may be configured to house, define, and/or include one or more additional components of system 10. In some examples, tank 12 may include or be subdivided into multiple tanks. For example, as shown in FIGS. 2 and 3, tank 12 may include a mud tank 14 configured to temporarily store collected waste materials (e.g., by way of a suction hose, boom line, etc.) and a water tank 16 configured to temporarily store water (e.g., water recycled from materials collected within mud tank 14). Like tank 12, mud tank 14 and/or water tank 16 may be at least partially cylindrical in configuration. For example, tank 12 may define one or more walls of mud tank 14 and/or water tank 16. In additional or alternative examples, tank 12, mud tank 14, and/or water tank 16 may have any other suitable shapes and/or configurations. For example, tank 12, mud tank 14, and/or water tank 16 may have a generally rectangular shape.

Mud tank 14 may include one or more enclosing structures defining the walls, roof, and/or floor of mud tank 14. For example, as shown in FIGS. 2 and 3, mud tank 14 may include one or more side walls 18, a roof 20, a back wall 22 (e.g., bordering and/or separating mud tank 14 from water tank 16), an end wall 24 (e.g., at an end of system 10) and a floor 26 that define mud tank 14, enclose mud tank 14, and/or separate mud tank 14 from water tank 16. In some examples mud tank 14 may be supported and/or partially suspended within tank 12 and/or water tank 16 by one or more braces located within water tank 16. For example, floor 26 and/or back wall 22 may be suspended above the bottom of water tank 16 and supported by one or more braces.

Mud tank 14 may additionally or alternatively include an opening 28 to facilitate removal of materials from mud tank 14. For example, opening 28 may be in one or more of side walls 18, roof 20, back wall 22, end wall 24, and floor 26. To illustrate, as shown in FIGS. 1, 2, and 3, opening 28 may be located within and proximate the base of end wall 24 (e.g., such that opening 28 is positioned near the rear of system 10 or a corresponding vacuum truck). In additional or alternative examples, opening 28 may be located at any other suitable position and/or as part of any other suitable structure(s) of mud tank 14. For example, opening may be located within floor 26 and/or side walls 18.

In some examples, a removable cover 30 may be mounted on mud tank 14 over the opening 28. Removable cover 30 may be configured to provide an air-tight seal over opening 28 to facilitate vacuuming operations and to selectively open to facilitate removal of any collected materials from mud tank 14. Accordingly, an operator may open removable cover 30 in order to access mud tank 14 and/or remove materials collected within mud tank 14. Removable cover 30 may be configured to be opened in any suitable manner (e.g., manually, mechanically, etc.). In some examples, system 10 may include a lift mechanism configured to assist the operator in opening and/or closing removable cover 30.

As mentioned above, mud tank 14 may include a floor 26 that extends between and/or is connected to side walls 18, back wall 22, and/or end wall 24. In some examples, as shown in FIGS. 2 and 3, floor 26 may slope in one or more directions. For example, floor 26 may be configured to slope towards opening 28 to utilize the natural effects of gravity to assist in the removal of materials from mud tank 14 through opening 28, without the need to physically lift or tip mud tank 14. To illustrate, as shown in FIGS. 2 and 3, floor 26 slopes downward as it extends from back wall 22 towards end wall 24 and opening 28. The angle of slope of floor 26 may be specifically tailored for a particular implementation (e.g., for a particular type of vacuum truck and/or materials). In some examples, the angle of the slope of floor 26 may be within the ranges of 5 to 60 degrees, 15 to 50 degrees, and/or 25 to 45 degrees.

Floor 26 may have any suitable shape, size, and/or configuration. In some examples, floor 26 may include a single piece (e.g., a single steel plate) that extends between side walls 18, back wall 22, and end wall 24. In additional or alternative embodiments, floor 26 may have one or more distinct, connected sections. For example, as shown in FIGS. 2, 5, and 6, floor 26 may include a central section 32 defining a central portion of floor 26 extending from back wall 22 to end wall 24 and opening 28. Floor 26 may also include one or more side sections 34 that define the sides of the floor 26 and extend outwards from central section 32 to side walls 18.

In some examples, as shown in FIGS. 2 and 5, side sections 34 may slope downward from side walls 18 towards central section 32. As a result, side sections 34 may direct collected materials within mud tank 14 towards central section 32 in order to facilitate the removal of the materials from mud tank 14. Side sections 34 may have any suitable slope, as may be desirable for a particular implementation. For example, a manufacturer of system 10 may select the slope of side sections 34 to suit a particular use for system 10 and/or in accordance with a particular type of waste materials that will be collected by system 10. In some examples, the angles of slope of side sections 34 relative to central section 32 may be within the range of 5 to 45 degrees.

Although central section 32 and side sections 34 are shown in the Figures as being generally flat pieces, one will appreciate that sections 32 and 34 may have any other suitable size, shape, and/or configuration whether regular or irregular. Similarly, floor 26 may have any suitable regular or irregular shape, size, and configuration. For example only, rather than including primarily flat surfaces, in additional or alternative embodiments, floor 26 may include one or more curved or stepped surfaces.

In addition to opening 28, mud tank 14 may also include other openings to facilitate vacuuming operations performed with system 10. For example, mud tank 14 may include an entrance port 36 for receiving materials into the mud tank 14 (e.g., by way of a suction hose and/or boom line). In addition, mud tank 14 and water tank 16 may be in fluid communication with each other by way of one or more pipes to facilitate the passage of air and/or water from mud tank 14 into water tank 16. For example, air and other vapors may be suctioned out of the mud tank 14 through an outlet port 38 and into water tank 16. Additionally or alternatively, the air and vapors may be suctioned through one or more filters, silencers, and/or separators prior to or after entering water tank 16. Mud tank 14 and/or water tank 16 may include any other suitable features or structures to facilitate the collection, storage, processing, and/or transportation of waste materials.

As mentioned above, system 10 may include one or more features to assist in removing collected materials from mud tank 14. For example, as shown in FIGS. 2, 3, 5, and 6, system 10 may include one or more devices, mechanisms, and/or structures for pushing, sweeping, or otherwise discharging collected materials out of the mud tank 14 and/or through opening 28. To illustrate, system 10 may include a paddle or blade 40 configured to move along the length of floor 26 to push or sweep materials collected within the mud tank 14 towards and/or through opening 28. Blade 40 may be configured to facilitate the most efficient removal of materials from mud tank 14. For example, blade 40 may be specifically configured to maximize the amount of materials that blade 40 is capable of moving and/or to otherwise facilitate the efficient removal of materials from mud tank 14. In some examples, blade 40 may have a concave shape and/or may include one or more angled flanges along the top, bottom, and/or sides of blade 40. To illustrate, as shown in FIGS. 2 and 3, blade 40 may include an upper flange 42 and a lower flange 44 angled towards opening 28 to increase the capacity of blade 40 and/or the ability of blade 40 to remove materials from the surface of floor 26. The angles of flanges 42 and 44 relative to the face of blade 40 may be configured as desired for a particular implementation. For example, in some embodiments, flanges 42 and 44 may each have an angle between 20 and 90 degrees with respect to the face of blade 40. In some examples, lower flange 44 may be angled so as to sit flush against the surface of floor 26. In additional or alternative embodiments, blade 40 may have any other suitable configuration, such as an “S blade” configuration, a “U blade” configuration, an “S-U” configuration, and/or any other suitable blade configuration as may be desirable for a particular implementation.

In some examples, blade 40 may be configured so that the bottom edge of blade 40 sits flush against floor 26, such that blade 40 may effectively scrape or dislodge collected materials from the surface of floor 26. For example, the configuration of the bottom edge of blade 40 may correspond to the configuration of the surface of floor 26. To illustrate, blade 40 may have a flat bottom edge to correspond to and interface with the generally flat surface of central section 32. Additionally or alternatively, blade 40 may have a width generally equal to or slightly narrower than the width of central section 32 to ensure that blade 40 can seat properly against the surface of central section 32. In some examples, blade 40 may also be narrow enough to at least partially fit into or through opening 28.

System 10 may additionally or alternatively include one or more structures or features to guide the movement of blade 40 along floor 26. For example, system 10 may include one or more guide rails 46 extending along the length of floor 26 and configured to guide the movement of blade 40 back and forth along floor 26. Additionally or alternatively, blade 40 may include a guide slot 48 configured to receive guide rail 46 such that relative movement of blade 40 is at least partially restricted in at least one direction by the interaction between guide rail 46 and guide slot 48. Guide rail 46 can have any suitable shape, size, and/or configuration. In turn, guide slot 48 may have a corresponding shape, size, and/or configuration. For illustrative purposes only, as shown in FIGS. 2, 4, and 5, guide rail 46 may have a generally T-shaped cross-section, and guide slot 48 may also be T-shaped. In some examples, the resulting interaction between guide rail 46 and guide slot 48 may restrict movement of blade 40 along multiple directional axes. For example, the interaction between guide rail 46 and guide slot 48 may allow blade 40 to move back and forth along the length of floor 26 while preventing blade 40 from moving sideways, up, or down relative to floor 26. As a result, the position of the blade 40 relative to and/or against the surface of floor 26 may be secured and/or maintained throughout the full range of movement of blade 40. System 10 may include any additional or alternative features and/or structures for guiding and/or restricting the movement of blade 40.

System 10 may include one or more drive mechanisms configured to move blade 40 back and forth along floor 26 in order to selectively push or sweep collected materials through opening 28 and out of mud tank 14. For example, as shown in FIGS. 2, 3, 5, and 6, system 10 may include one or more hydraulic cylinders 50 connected to blade 40 and configured to selectively move blade 40 back and forth along floor 26. Hydraulic cylinders 50 may connect to blade 40 at one end and may connect to tank 12, water tank 16, or some other fixed structure of system 10 at the other end. In some examples, the connection between hydraulic cylinders 50 and blade 40 may be a fixed connection that does not allow movement (e.g., rotation) of blade 40 relative to hydraulic cylinders 50, to provide sufficient rigidity and strength to blade 40.

Hydraulic cylinders 50 may extend at least partially out of mud tank 14. For example, hydraulic cylinders 50 may extend at least partially into and/or through water tank 16. In some examples, hydraulic cylinders 50 may extend through a back wall of water tank 16, as shown in FIGS. 3 and 6. In additional or alternative examples, hydraulic cylinders 50 may be positioned within system 10 and/or connected to other components of system 10 in any other suitable manner, as may serve a particular implementation.

As shown in FIG. 3, hydraulic cylinders 50 may be at least partially housed within and/or protected by hydraulic cylinder housings 52 (or simply “housings 52”). In some examples, housings 52 may be tubular and house the portions of hydraulic cylinders 50 that extend outside of mud tank 14. To illustrate, as shown in FIG. 3, a “barrel” or “body” 54 of each hydraulic cylinder 50 may be housed and/or fixedly connected within a corresponding housing 52, while a piston rod 56 of each hydraulic cylinder 50 may extend from housing 52 into mud tank 14 to connect to blade 40. Housings 52 and/or the point of entry of piston rods 56 into mud tank 14 may include an air-tight seal so as not to deteriorate any suction forces within mud tank 14. In additional or alternative embodiments, bodies 54 of hydraulic cylinders 50 may extend at least partially into mud tank 14. In additional or alternative embodiments, housings 52 may provide a point of access to hydraulic cylinders 50 located outside of tank 12. For example, at the ends opposite mud tank 14, housings 52 may have removable plates through which an operator or mechanic may access hydraulic cylinders 50 without having to physically enter tank 12, mud tank 14, or water tank 16.

Hydraulic cylinders 50 may be operably connected to one or more corresponding hydraulic pumps that may be selectively actuated to extend and/or retract piston rods 56 and blade 40. Accordingly, an operator may utilize a control panel, one or more levers, or any other suitable control device to selectively actuate hydraulic cylinders 50 to effectuate movement of blade 40 back and forth along floor 26 in the direction indicated by arrows 57 shown in FIG. 2 and along a path that is generally parallel with hydraulic cylinders 50. By so doing, the operator may safely and efficiently push materials collected within mud tank 14 out of opening 28, without the need to lift mud tank 14 or manually remove the collected materials.

In some examples, the actuation of blade 40 may be at least partially automated. For example, system 10 may include one or more sensors in communication with a control panel and configured to sense the presence of materials within mud tank and/or the absence of any human operators within mud tank. In response to signals from the sensors indicating that materials remain in mud tank 14 and there are no safety hazards (e.g., there are no operators in or near mud tank 14), system 10 may automatically actuate blade 40 to discharge the sensed materials from mud tank 14. Similarly, system 10 may include one or more sensors configured to automatically disable the actuation of blade 40 in response to a detected mechanical failure or safety hazard. In additional or alternative embodiments, a control panel associated with system 10 may be remotely located relative to mud tank 14 and allow an operator to control blade 40 from a remote and safe location.

The specifications of hydraulic cylinders 50, including the bore size, stroke length, rod diameter, max load, etc., may be specifically tailored or selected as desired for a particular implementation. In some examples, the stroke length of hydraulic cylinders 50 may be selected to achieve the greatest range of motion of blade 40 and/or to allow blade 40 to extend to a position close to or at least partially through opening 28.

In additional or alternative embodiments, system 10 may include any other suitable drive mechanism for actuating blade 40. For example, system 10 may include a belt drive mechanism, a chain drive mechanism, a screw drive mechanism, and/or any other suitable drive mechanisms capable of moving blade 40 back and forth along floor 26 to push collected materials through opening 28.

As shown in FIGS. 2, 3, and 6, system 10 may additionally or alternatively include a spray bar 58. Spray bar 58 may be configured to further facilitate the removal of materials from mud tank 14. For example, spray bar 58 may be configured to allow an operator spray out the inside of mud tank 14 without having to physically enter mud tank 14. Spray bar 58 may be configured to direct water or other fluids to various surfaces of mud tank 14. As shown, in some examples, spray bar 58 may be mounted on an upper portion of back wall 22 of mud tank 14. In additional or alternative examples, spray bar 58 may be mounted at any other suitable location.

Spray bar 58 may be in fluid communication with a fluid entry port 60 through which an operator may introduce water or other fluids for passage through spray bar 58. For example, an operator may connect a hose or spray wand to fluid entry port 60 to spray fluids through spray bar 58. Additionally or alternatively, fluid entry port 60 may be in fluid communication with a water pump that an operator may selectively actuate to pump water through spray bar 58.

Spray bar 58 may be configured to clean one or more internal surfaces of mud tank 14. For example, as shown in FIG. 7, which illustrates a detailed view of spray bar 58, spray bar 58 may have a tubular configuration including a plurality of fluid exit ports 62 (or simply “exit ports 62”) through which fluid may be sprayed into the interior of mud tank 14. Spray bar 58 may have any suitable number and/or configuration of exit ports 62 as may be desirable for a particular implementation. For example, spray bar 58 may have one or more exit ports 62 along the bottom of spray bar, one or more exit ports 62 along the front of spray bar 58, one or more exit ports 62 along the top of spray bar 58, and/or one or more exit ports 62 along the back of spray bar 58. Each exit port 62 may have any suitable size and shape and/or may be configured to produce any desired size and shape of spray. In some examples, one or more exit ports 62 may have a rectangular shape and/or may be configured to produce a fan-shaped spray. In additional or alternative embodiments, one or more exit ports 62 may have any other suitable size and/or shape (e.g., circular, oval, square, angular, etc.).

Exit ports 62 may be directed in any suitable direction. For example, one or more exit ports 62 may be directed at one or more of side walls 18, roof 20, back wall 22, end wall 24, a floor 26, blade 40, and/or any other suitable portion of system 10 and/or mud tank 14. In additional or alternative embodiments, spray bar 58 may include one or more diverter plates 64 configured to direct the stream of spray from exit ports 62 in any desired directions. Diverter plates 64 may be attached (e.g., welded, glued, etc.) to and/or extend from spray bar 58 at any suitable position and/or angled in any suitable direction. In some examples, spray bar 58 may include diverter plates 64 near some but not all of exit ports 62. The inclusion, angle, and/or position of diverter plates 64 may be strategically varied in order to effectively spread the spray from spray bar 58 to different portions and/or surfaces of mud tank 14. By so doing, spray bar 58 may successfully assist in cleaning the interior of mud tank 14.

To illustrate the use of system 10, once system 10 has been utilized to collect waste materials within mud tank 14, an operator may open cover 30 and actuate blade 40 to push collected materials out of opening 28. The operator may repeat this process by extending and retracting blade 40 as many times as necessary to push the collected materials out of opening 28. Separate from or in conjunction with actuation of blade 40, the operator may spray fluids through spray bar 58 to clean out any remaining materials adhering to the surfaces within mud tank 14. The sprayed fluid and materials may then run and/or be pushed out of opening 28.

In additional or alternative embodiments, system 10 may include any other features and/or devices to facilitate the removal of collected materials from mud tank 14. For example only, system 10 may include one or more vibration units, one or more air cannons, and/or any other devices configured to facilitate removal of build up to the surfaces of mud tank 14. The internal surfaces of mud tank 14 may additionally or alternatively be coated and/or lined with one or more non-stick materials to help prevent material from adhering to the surfaces of mud tank 14.

System 10 may be manufactured using any suitable materials connected in any suitable manner. For example, system 10 may be manufactured using one or more steel plates and/or steel cylinders welded or bolted together to form various parts of system 10. In additional or alternative embodiments, system 10 may be manufactured using any other suitable materials (e.g., plastics, metals, rubbers, etc.) connected in any other suitable manner.

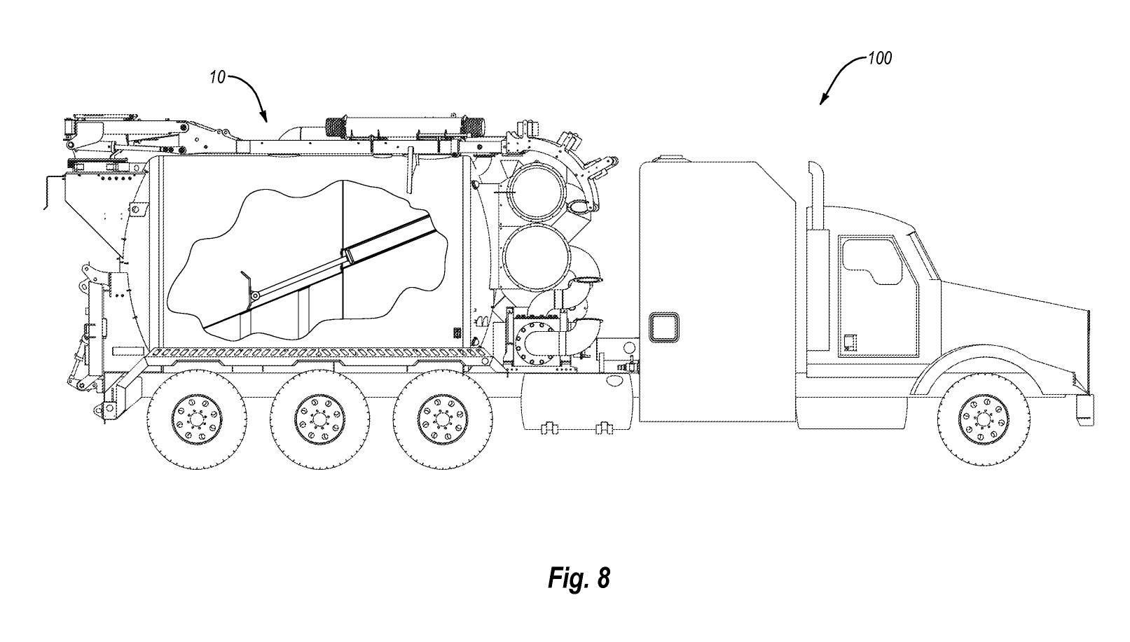

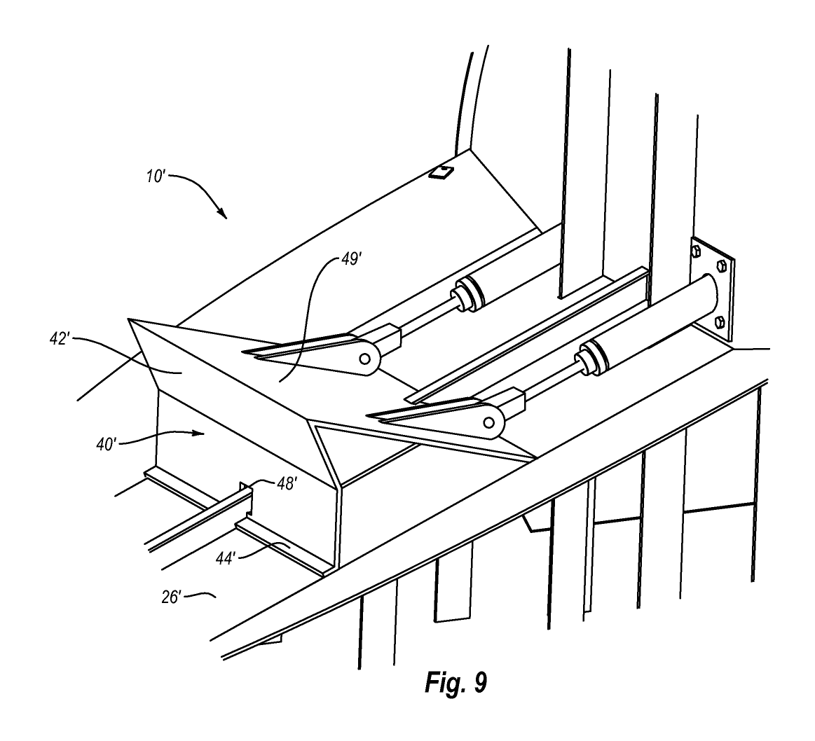

System 10 may be utilized in accordance with a vacuum truck. To illustrate, FIG. 8 shows an exemplary vacuum truck 100 including system 10 and manufactured according to the principles described herein. Vacuum truck 100 may be a hydrovac truck having a frame mounted on wheels. As shown in FIG. 8, system 10 may then be mounted (e.g., bolted, welded, etc.) onto the frame of vacuum truck 100. For clarity and to avoid unnecessarily complicating FIG. 8, the components of system 10 are not labeled with their respective numerals in FIG. 8, as such references can be found in FIGS. 1-7.

Vacuum truck 100 may include any other devices and/or mechanisms (e.g., blowers, water pumps, hydraulic pumps, separators, silencers, filters, etc.) necessary or helpful for pneumatically collecting waste materials into system 10. In some examples, vacuum truck 100 may include one or more power take offs (“PTOs”) operably connected to vacuum truck 100 and configured to power one or more mechanisms of vacuum truck 100. For example, vacuum truck 100 may include a blower that is powered by a PTO (e.g., a drive shaft) operably connected to the transmission and/or engine of the vacuum truck 100.

An operator may utilize vacuum truck 100 to collect materials into tank 12, and specifically into mud tank 14. Once the materials have been collected and/or transported to a desired location, the operator may utilize the functionality of system 10 to remove or discharge the collected materials from vacuum truck 100 for processing or disposal. System 10 allows the operator to remove the collected materials from vacuum truck 100 without lifting the tanks of vacuum truck 100 and/or with minimal physical labor. Accordingly, the operator can more efficiently, effectively, and safely remove collected materials from vacuum truck 100. Furthermore, because vacuum truck 100 may have fewer moving parts and components than conventional vacuum trucks, vacuum truck 100 may be more economical to build and maintain.

As mentioned above, the features and components of system 10 may be varied in any suitable manner as may be desired for a particular implementation. For example only, FIG. 9 illustrates an alternative system 10′ that may be similar in many respects to system 10 illustrated in FIGS. 1-8. However, FIG. 9 shows one or more modifications that can be made to the system 10. For example and not limitation, system 10′ includes a modified blade 40′. As shown, blade 40′ may be similar in many respects to blade 40 discussed in more detail above. For example, blade 40′ may include an upper flange 42′, a lower flange 44′, and a guide slot 48′. Additionally or alternatively, blade 40′ may include a back sweep or blade face 49′ (or simply “back face 49′”). Back face 49′ may angle from the top of blade 40′ backwards and down to the surface of floor 26′. In some examples, back face 49′ may be configured to facilitate the return of blade 40′ from an extended position to a retracted position. For example, back face 49′ may be configured to sweep away materials that have collected behind blade 40′ as blade 40′ returns to its retracted position. This may help prevent debris from getting lodged under blade 40′ and/or preventing blade 40′ from properly retracting. Back face 49′ may have any suitable angle and/or configuration to sweep away materials as blade 40′ retracts. Back face 49′ may additionally or alternative have one or more flanges to facilitate the sweeping of materials. System 10′ may have any other suitable modifications that may assist in the effective and safe removal of materials from within mud tank 14.

One will appreciate that the systems and devices disclosed herein may be modified in a number of additional or alternative ways while remaining within the scope of this disclosure.

We claim:

1. A system for removing materials from a vacuum truck comprising:
a tank including a mud tank and a water tank, wherein the mud tank comprises:
one or more walls enclosing the mud tank,
an opening in the one or more walls of the mud tank to facilitate removal of materials from the mud tank,
a removable cover mounted on the mud tank and configured to selectively cover the opening in the mud tank, and
a floor extending between the one or more walls and having a downward slope towards the opening;
a blade positioned within the mud tank and configured to push materials on the floor of the mud tank towards the opening in the mud tank; and
a drive mechanism configured to selectively move the blade along the floor towards the opening in the mud tank; and
a guide rail extending along a length of the mud tank, wherein the guide rail is configured to guide movement of the blade.

2. The system of claim 1, further comprising a spray bar within the mud tank, the spray bar comprising one or more fluid exit ports configured to direct fluid at one or more surfaces of the mud tank.

3. The system of claim 2, wherein the spray bar further comprises one or more diverter plates configured to direct fluid from at least one of the one or more fluid exit ports towards one or more surfaces of the mud tank.

4. The system of claim 2, wherein the spray bar is in fluid communication with a fluid entry port.

5. The system of claim 4, wherein the fluid entry port is configured to receive fluid from at least one of a pump, a hose, and a spray wand.

6. They system of claim 1, wherein the blade includes a back blade face configured to sweep away materials behind the blade as the blade retracts.

7. The system of claim 1, wherein the floor has multiple distinct sections and is at least partially suspended above a floor of the water tank

8. The system of claim 7, wherein the multiple distinct sections of the floor include a central section that slopes towards the opening in the mud tank and one or more side sections that angle inward towards the central section.

9. The system of claim 1, wherein the guide rail extends along the floor of the mud tank.

10. The system of claim 9, wherein the blade includes a guide slot configured to receive the guide rail and interact with the guide rail to restrict movement of the blade in one or more directions relative to the floor.

11. The system of claim 10, wherein the interaction between the guide rail and the guide slot at least partially restricts sideways or upwards movement of the blade relative to a surface of the floor.

12. The system of claim 10, wherein the guide slot and a cross-section of the guide rail are both T-shaped.

13. The system of claim 1, wherein the drive mechanism is further configured to selectively retract the blade away from the opening.

14. The system of claim 1, wherein the drive mechanism comprises one or more hydraulic cylinders.

15. The system of claim 14, wherein the one or more hydraulic cylinders at least partially extend outside of the mud tank and into the water tank.

16. The system of claim 14, wherein the one or more hydraulic cylinders are at least partially housed within one or more housings.

17. The system of claim 14, wherein the one or more hydraulic cylinders are fixedly connected to the blade.

18. The system of claim 14, wherein the path of movement of the blade is generally parallel to the orientation of the one or more hydraulic cylinders.

19. The system of claim 1, wherein the one or more drive mechanisms comprises at least one of a belt drive mechanism, a chain drive mechanism, and a screw drive mechanism.

20. The system of claim 1, wherein the one or more walls comprises one or more side walls, a back wall, and an end wall.

21. The system of claim 20, wherein the opening is located within the end wall.

22. The system of claim 1, wherein the blade has one or more flanges along a top, a bottom, or one or more sides of the blade.

23. The system of claim 22, wherein the one or more flanges comprise a top flange and a bottom flange that angle towards the opening.

24. A system for removing materials from a vacuum truck comprising:
a tank for temporarily storing collected materials, the tank comprising:
one or more walls enclosing the tank,
an opening in the one or more walls of the tank to facilitate removal of materials from the tank,
a removable cover mounted on the tank and configured to selectively cover the opening in the tank, and
a floor extending between the one or more walls and having a downward slope towards the opening;
a blade positioned within the tank and configured to push materials on the floor of the tank towards the opening in the tank;
a drive mechanism configured to selectively move the blade along the floor towards the opening in the tank and retract the blade away from the opening; and
a spray bar within the tank, the spray bar comprising one or more fluid exit ports configured to direct fluid at one or more surfaces of the tank.

25. The system of claim 24, further comprising a guide rail extending along the floor of the tank, the guide rail being configured to guide movement of the blade along the floor.

26. The system of claim 25, further comprising a guide slot in the blade being configured to receive the guide rail and interact with the guide rail to restrict movement of the blade in one or more directions relative to the floor.

27. The system of claim 26, wherein the interaction between the guide rail and the guide slot at least partially restricts sideways or upwards movement of the blade relative to a surface of the floor.

28. The system of claim 24, wherein the spray bar further comprises one or more diverter plates configured to direct fluid from at least one of the one or more fluid exit ports towards one or more surfaces of the tank.

29. They system of claim 24, wherein the blade includes a back blade face configured to sweep away materials behind the blade as the blade retracts.

30. A vacuum truck comprising:
a frame mounted on wheels;
a tank including a mud tank and a water tank, wherein the tank is mounted on the frame and wherein the mud tank comprises:
one or more walls enclosing the mud tank,
an opening in the one or more walls of the mud tank to facilitate removal of materials from the mud tank,
a removable cover mounted on the mud tank and configured to selectively cover the opening in the mud tank, and
a floor extending between the one or more walls and having a downward slope towards the opening, wherein the floor has multiple distinct sections and is at least partially suspended above a floor of the water tank;
a blade positioned within the mud tank and configured to push materials on the floor of the mud tank towards the opening in the mud tank;
a drive mechanism configured to selectively move the blade along the floor towards the opening in the mud tank; and
a guide rail extending along the floor of the mud tank, the guide rail being configured to guide movement of the blade along the floor of the mud tank.

31. The system of claim 30, further comprising a spray bar within the mud tank, the spray bar comprising one or more fluid exit ports configured to direct fluid at one or more surfaces of the mud tank.

32. The system of claim 31, wherein the spray bar further comprises one or more diverter plates configured to direct fluid from at least one of the one or more fluid exit ports towards one or more surfaces of the mud tank.

33. They system of claim 30, wherein the blade includes a back blade face configured to sweep away materials behind the blade as the blade retracts.

34. The vacuum truck of claim 30, further comprising a guide slot in the blade, wherein the guide slot is configured to receive the guide rail and interact with the guide rail to restrict movement of the blade in one or more directions relative to the floor of the mud tank.

35. The vacuum truck of claim 34, wherein the interaction between the guide rail and the guide slot at least partially restricts sideways or upwards movement of the blade relative to a surface of the floor.

36. The vacuum truck of claim 30, wherein the drive mechanism comprises one or more hydraulic cylinders that extend outside of the mud tank and at least partially into the water tank.
